(19) United States
(12) Patent Application Publication
(10) Pub. No.: US 2004/0217277 A1
(43) Pub. Date: Nov. 4, 2004

(54) Apparatus and method for surface activation and selective ion generation for MALDI mass spectrometry

(76) Inventors: Paul C. Goodley, Cupertino, CA (US); Jean-Luc Truche, Los Altos, CA (US); Jian Bai, Sunnyvale, CA (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/427,543

(22) Filed: Apr. 30, 2003

(51) Int. Cl. H01J 49/04

(52) U.S. Cl. 250/288

(57) ABSTRACT

The present invention relates to an apparatus and method for use with a mass spectrometer system. The mass spectrometer system, comprises a irradiating source for ionizing a matrix based sample, a target substrate adjacent to the irradiating source for supporting the matrix based sample, the target substrate having a target surface comprising a hydrophobic material for concentrating the matrix based sample on the target surface before it is ionized to analyte ions that are discharged to the ionization region. A collecting capillary is downstream from the irradiating source for receiving the analyte ions produced and discharged from the target substrate to the ionization region. A detector is also downstream from the collecting capillary for detecting the analyte ions received from the collecting capillary.

A method for producing analyte ions in a mass spectrometer system is also disclosed.

### TECHNICAL FIELD

The invention relates generally to the field of mass spectrometry and more particularly toward an apparatus and method for surface activation and selective ion generation for matrix assisted laser desorption/ionization mass spectrometry (MALDI) and atmospheric pressure matrix assisted laser desorption/ionization mass spectrometry (AP-MALDI).

### BACKGROUND

Most complex biological and chemical targets require the application of complementary multidimensional analysis tools and methods to compensate for target and matrix interferences. Correct analysis and separation are important to obtain reliable quantitative and qualitative information about a target. In this regard, mass spectrometers have been used extensively as detectors for various separation methods. However, until recently most spectral methods provided fragmentation patterns that were too complicated for quick and efficient analysis. The introduction of atmospheric pressure ionization (API) and matrix assisted laser desorption ionization (MALDI) has improved results substantially. For instance, these methods provide significantly reduced molecular fragmentation patterns and high sensitivity for analysis of a wide variety of both volatile and non-volatile compounds. The techniques have also had success on a broad based level of compounds including peptides, proteins, carbohydrates, oligosaccharides, natural products, cationic drugs, organoarsenic compounds, cyclic glucans, taxol, taxol derivatives, metalloporphyrins, porphyrins, kerogens, cyclic siloxanes, aromatic polyester dendrimers, oligodeoxynucleotides, synthetic polymers and lipids.

According to the MALDI method of ionization, the analyte and matrix are applied to a metal probe or target substrate. As the solvent evaporates, the analyte and matrix co-precipitate out of solution to form a solid solution of the analyte in the matrix onto the target substrate. The co-precipitate is then irradiated with a short laser pulse inducing the accumulation of a large amount of energy in the co-precipitate through electronic excitation or molecular vibration of the matrix molecules. The matrix dissipates the energy by desorption, carrying along the analyte into the gaseous phase. During this desorption process, ions are formed by charge transfer between the thermal and photo-excited matrix and analyte.

Conventionally, the MALDI technique of ionization is performed using a time-of-flight analyzer, although other mass analyzers such as an ion trap, an ion cyclotron resonance mass spectrometer and a quadrupole mass filter may be used. These analyzers, however, must operate under high vacuum, which among other things may limit the target throughput, reduce resolution and capture efficiency, and make testing targets more difficult and expensive to perform.

To overcome the above-mentioned disadvantages in MALDI, a technique referred to as AP-MALDI has been developed. This technique employs the MALDI technique of ionization, but at atmospheric pressure. The MALDI and the AP-MALDI ionization techniques have much in common. For instance, both techniques are based on the process of pulsed laser beam desorption/ionization of a solid-state target material resulting in production of gas phase analyte molecular ions. However, the AP-MALDI ionization technique depends heavilty on a pressure differential between the ionization chamber and the mass spectrometer to direct the flow of ions into the inlet orifice of the mass spectrometer.

AP-MALDI can provide detection of a molecular mass up to 10⁶ Daltons (Da) from a target size in the low attamole range. In addition, as large groups of proteins, peptides or other compounds are being processed and analyzed by these instruments, levels of sensitivity become increasingly important. Various structural and instrument changes have been made to MALDI mass spectrometers in an effort to improve sensitivity. Additions of parts and components, however, result in increased instrument cost. In addition, attempts have been made to improve sensitivity by altering the analyte matrix mixed with the target. These additions and changes, however, have provided limited improvements in sensitivity with added cost.

More recently, efforts have focused on improving the instrument sensitivity by improving the target substrates. Robust ionization surfaces have been produced using surface coating processes such as titanium nitride or semi-conductor grade silicon. These coatings and processes, however, fail to effectively increase overall sensitivity in the instrument and often provide additional noise to the samples. In addition, since most of the target substrates comprise hydrophilic materials, it is often difficult to effectively and efficiently ionize samples. Hydrophillic surfaces produce a solvent drying before crystallization that creates uneven crystals and/or forms craters due to the drying of sample that takes place from the rim to the center of the sample. It would, therefore, be desirable to provide a target substrate that improves seeding of crystals via nucleation, and provides improved crystal packing, or increased homogeneity of sample and matrix before they are irradiated and subsequently ionized.

Thus, there is a need to improve the sensitivity and results of MALDI and AP-MALDI mass spectrometers for improved ion production.

### SUMMARY OF THE INVENTION

The present invention relates to an apparatus and method for use with a mass spectrometer system. The invention provides a mass spectrometer system comprising an ion source having a target substrate with a target substrate surface comprising a hydrophobic material such as a methyl silicone material for producing analyte ions, an ion transport system adjacent to the ion source for transporting ions from the ion source, and an ion detector downstream from the ion source for detecting the analyte ions.

The method of the present invention comprises concentrating analyte ions on a target substrate surface comprised of a hydrophobic material such as methyl silicone, ionizing and discharging the ions to an ionization region, and detecting the analyte ions with a detector.

### BRIEF DESCRIPTION OF THE FIGURES

The invention is described in detail below with reference to the following figures:

FIG. 1 shows general block diagram of a mass spectrometer.

FIG. 2 shows a cross-sectional view of the present invention.

FIG. 3A shows a magnified view of coated and non-coated positions on a target substrate of the present invention.

FIG. 3B shows a magnified view of coated and non-coated positions on a target substrate of the present invention.

FIG. 4A shows MALDI spot formation and dispersion on a non-coated glass target substrate.

FIG. 4B shows MALDI spot formation and concentration on a coated glass target substrate of the present invention.

FIG. 5A shows the results of a low femto molar peptide mixture on an AP-MALDI untreated target substrate.

FIG. 5B shows the results of the same femto molar peptide mixture on a treated AP-MALDI target substrate of the present invention.

### DETAILED DESCRIPTION OF THE INVENTION

Before describing the invention in detail, it must be noted that, as used in this specification and the appended claims, the singular forms “a,” “an,” and “the” include plural referents unless the context clearly dictates otherwise. Thus, for example, reference to “a target substrate” includes more than one “target substrate”. Reference to a “matrix” includes more than one “matrix” or a mixture of “matrixes”. In describing and claiming the present invention, the following terminology will be used in accordance with the definitions set out below.

The term “adjacent” means, near, next to or adjoining. Something adjacent may also be in contact with another component, surround the other component, be spaced from the other component or contain a portion of the other component. For instance, a target substrate that is adjacent to a conduit may be spaced next to the conduit, may contact the conduit, may surround or be surrounded by the conduit, may contain the conduit or be contained by the conduit, may adjoin the conduit or may be near the conduit.

The term “ion source” or “source” refers to any source that produces analyte ions. Ion sources may include other sources besides AP-MALDI ion sources such as electron impact (herein after referred to as EI), chemical ionization (CI) and other ion sources known in the art. The term “ion source” refers to the apparatus comprising the laser, target substrate, and target to be ionized on the target substrate. The target substrate in AP-MALDI may include a grid for target deposition. Spacing between targets on such grids is around 0.4-10 mm. Approximately 0.2 to 2 micro liters of target is deposited on each site on the grid.

The term “ionization region” refers to the volume between the ion source and the collecting capillary. In particular, the term refers to a region containing analyte ions produced by the ion source and which have not yet been channeled into the collecting capillary. This term should be interpreted broadly to include a region containing ions in, on, about or around the target substrate as well as ions in the heated gas phase above and around the target substrate and collecting capillary. The ionization region in AP MALDI is about 0.2-5 mm in distance from the ion source (target substrate) to a collecting capillary (or a volume of typically about 1-5 mm³). The distance from the target substrate to the conduit may be chosen such as to allow ample gas to flow from the conduit toward the target and target substrate. For instance, if the conduit is too close to the target or target substrate, then arcing takes place when voltage is applied. If the distance is too far, then ion collection is inefficient.

The term “ion transport system” refers to any device, apparatus, machine, component, capillary, that shall aid in the transport, movement, or distribution of analyte ions from one position to another. The term is broad based to include ion optics, skimmers, capillaries, conducting elements and conduits.

The terms “matrix based”, or “matrix based ion source” refers to an ion source or mass spectrometer system that does not require the use of a drying gas, curtain gas, or desolvation step. For instance, some systems require the use of such gases to remove solvent or cosolvent that is mixed with the analyte. These systems often use volatile liquids to help form smaller droplets. The above term applies to both nonvolatile liquids and solid materials in which the sample is dissolved. The term includes the use of a cosolvent. Cosolvents may be volatile or nonvolatile, but must not render the final matrix material capable of evaporating in vacuum. Such materials would include, and not be limited to m-nitro benzyl alcohol (NBA), glycerol, triethanolamine (TEA), 2,4-dipentylphenol, 1,5-dithiothrietol/dierythritol (magic bullet), 2-nitrophenyl octyl ether (NPOE), thioglycerol, nicotinic acid, cinnamic acid, 2,5-dihydroxy benzoic acid (DHB), 3,5-dimethoxy-4-hydroxycinnamic acid (sinpinic acid), α-cyano-4-hydroxycinnamic acid (CCA), 3-methoxy-4-hydroxycinnamic acid (ferulic acid), ), monothioglycerol, carbowax, 2-(4-hydroxyphenylazo)benzoic acid (HABA), 3,4-dihydroxycinnamic acid (caffeic acid), 2-amino-4-methyl-5-nitropyridine with their cosolvents and derivatives. In particular the term refers to MALDI, AP-MALDI, fast atom/ion bombardment (FAB) and other similar systems that do not require a volatile solvent and may be operated above, at, and below atmospheric pressure.

The term “gas flow”, “gas”, or “directed gas” refers to any gas that is directed in a defined direction in a mass spectrometer. The term should be construed broadly to include monatomic, diatomic, triatomic and polyatomic molecules that can be passed or blown through a conduit. The term should also be construed broadly to include mixtures, impure mixtures, or contaminants. The term includes both inert and non-inert matter. Common gases used with the present invention could include and not be limited to ammonia, carbon monoxide, carbon dioxide, helium, fluorine, oxygen, argon, xenon, nitrogen, air, methane, ethane, fluorohydrocarbons, sulfurhexafloride, etc..

The term “gas source” refers to any apparatus, machine, conduit, or device that produces a desired gas or gas flow. Gas sources often produce regulated gas flow, but this is not required.

The term “capillary” or “collecting capillary” shall be synonymous and will conform to the common definition(s) in the art. The term should be construed broadly to include any device, apparatus, tube, hose or conduit that may receive ions.

The term “detector” refers to any device, apparatus, machine, component, or system that can detect an ion. Detectors may or may not include hardware and software. In a mass spectrometer system a detector includes and/or is coupled to a mass analyzer.

The term “irradiating source” refers to any source that may subject a target to radiation or irradiation by focus or concentration of atoms, light, ultraviolet light, electromagnetic radiation, particles, neutrons, protons, ions and electrons.

The invention is described with reference to the figures. The figures are not to scale, and in particular, certain dimensions may be exaggerated for clarity of presentation.

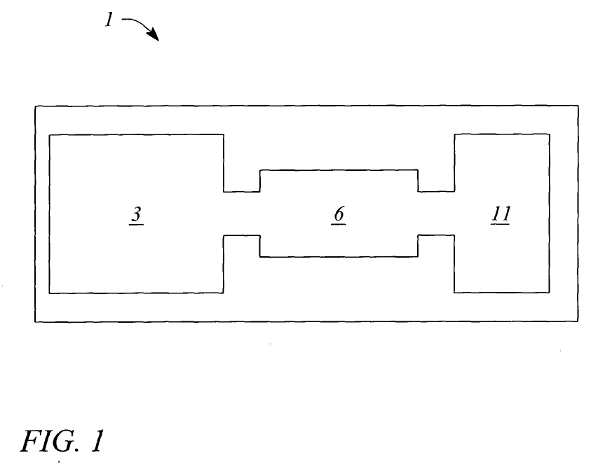

FIG. 1 shows a general block diagram of a mass spectrometer. The block diagram is not to scale and is drawn in a general format because the present invention may be used with a variety of different types of mass spectrometer systems. A mass spectrometer system 1 of the present invention comprises an ion source 3, an ion transport system 6 and a detector 11.

The ion source 3 may be located in a number of possible positions or locations. The ion transport system 6 is adjacent to the ion source 3 and may comprise a collecting capillary 7 or any ion optics, conduits or devices that may transport analyte ions and that are well known in the art.

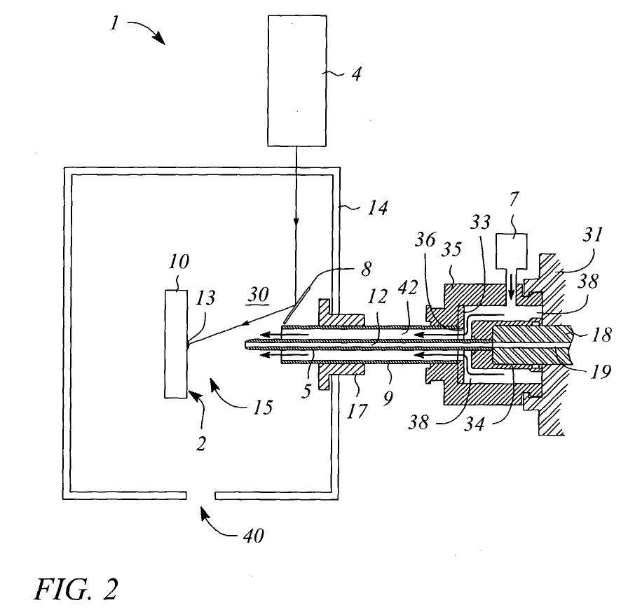

FIG. 2 shows a cross-sectional view of a first embodiment of the invention. The figure shows the present invention applied to an AP-MALDI mass spectrometer system. For simplicity, the figure shows the invention with a source housing 14. The use of the source housing 14 to enclose the ion source 3 and system is optional. Certain parts, components and systems may or may not be under vacuum.

The ion source 3 comprises an irradiating source 4 such as a laser, a deflector 8 and a target substrate 10. A target 13 is applied to the target substrate 10 in a matrix material well known in the art. The irradiating source 4 provides an irradiating source beam that is deflected by the deflector 8 toward the target 13. The target 13 is then ionized and the analyte ions are released as an ion plume into an ionization region 15. The irradiating source 4 provides an irradiating source beam that ionizes a sample within a defined volume or on a target substrate surface area of 200 microns. The irradiating source 4 begins at one portion of the target substrate 10 and effectively samples across the target substrate surface 2. The effective area can range from about 1 to 5 millimeters.

The ionization region 15 is located between the ion source 3 and the collecting capillary 5. The ionization region 15 comprises the space between the ion source 3 and the collecting capillary 5. This region contains the ions produced by ionizing the sample that are vaporized into a gas phase. This region can be adjusted in size and shape depending upon how the ion source 3 is arranged relative to the collecting capillary 5. Most importantly, located in this region are the analyte ions produced by ionization of the target 13.

The collecting capillary 5 is located downstream from the ion source 3 and may comprise a variety of material and designs that are well known in the art. The collecting capillary 5 is designed to receive and collect analyte ions produced from the ion source 3 that are discharged as an ion plume into the ionization region 15. The collecting capillary 5 has an aperture and/or elongated bore 12 that receives the analyte ions and transports them to another capillary or location. In FIG. 2 the collecting capillary 5 is connected to a main capillary 18 that has a main capillary bore 19. The main capillary 18 is under vacuum and further downstream. Other structures and devices well known in the art may be used to support the collecting capillary 5.

The gas source 7 provides the gas to the channel 38. The gas source 7 may comprise any number of devices. Gas sources are well known in the art and are described elsewhere. The gas source 7 may provide a number of gases to the conduit 9. For instance, gases such as nitrogen, argon, xenon, carbon dioxide, air, helium etc. may be used with the present invention. The gas need not be inert and should be capable of carrying sufficient energy or heat. Other gases well known in the art that exhibit thermal and inert properties may also be used with the present invention.

Referring now to FIGS. 1-2, the detector 11 is located downstream from the ion source 3 and the target substrate 10. The detector 11 may be a mass analyzer or other similar device well known in the art for detecting the analyte ions that were collected by the collecting capillary 5 and transported to the main capillary 18. The detector 11 may also comprise any computer hardware and software that are well known in the art and which may help in detecting analyte ions. The collecting capillary 5 is connected to the main capillary 18 by the capillary cap 34. The capillary cap 34 is designed for receiving the main capillary 18 and is disposed in the housing 35. The housing 35 connects directly to the fixed support 31. Note that the gas source 7 provides the gas through the channels 38 defined between the housing 35 and the capillary cap 34. The gas flows from the gas source 7 into the channel 38 and into the annular space 42 of the conduit 9 and then into an ionization chamber 30.

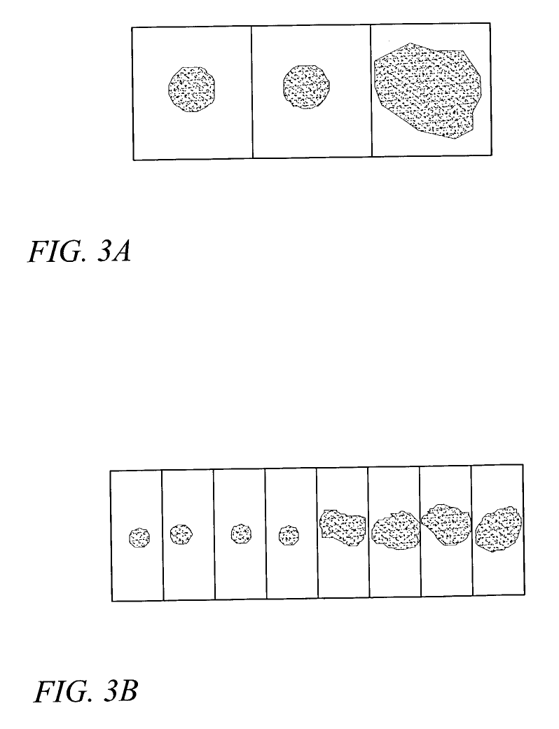

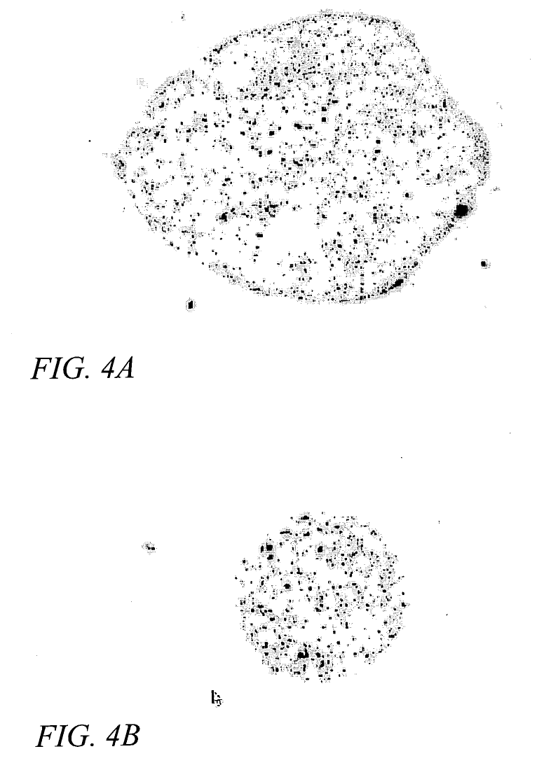

FIGS. 3A-4B show the target substrate 10 of the present invention with and without treatments. Many target substrate surfaces and materials often comprise a hydrophilic material or coating. These materials and coating although convenient to use and manufacture provide ionization problems in MALDI and AP-MALDI. FIGS. 3A and 3B show the droplet spreading on a non-treated titanium nitride target substrate and a target substrate with the hydrophobic coating of the present invention. In FIG. 3A equal volumes of sample were dispensed onto a plate with treated and non-treated positions (two left positions are treated with the present invention and show smaller spots) and an untreated position (right position shows larger spot with dispersion). The treated positions showed a tightly formed droplet with reduced spreading and the non-treated position showed spreading effects. FIG. 3B shows similar results with the four left positions being treated and the four right positions being non-treated.

It should be mentioned that although the figures show the application of a coating, the entire target substrate or parts of the target substrate might comprise a hydrophobic material or polymer such as the methyl silicone gum rubber. Other materials may be used in place of this material that promotes a decrease in surface tension and a strong hydrophobic surface response.

FIG. 4A-4B show a MALDI precipitated-spot on a glass plate with and without the coating of the present invention. These figures show similar results to FIGS. 3A-3B. Applications and coatings may be similar to those described above.

Having described the invention and components in some detail, a description of how the invention operates is in order.

The method of the present invention comprises applying a hydrophobic material to a target substrate surface 2 for concentrating a matrix based sample, ionizing the matrix based sample to produce analyte ions, and detecting the analyte ions. The material may comprise any of a number of hydrophobic materials. For instance, the material may comprise a polymeric material such as methyl silicone gum rubber. The material may be applied directly to the surface of target substrate 10 as a coating or may comprise the entire target substrate 10. For instance, the target substrate 10 may be a solid methyl silicone gum rubber material. If the present invention is applied as a coating it may be applied to the entire surface of target substrate 10 or may only be applied to a portion of the target substrate 10.

The target substrate 10 of the present invention produces an increased quantity of analyte ions for detection in the mass spectrometer 1. It should be noted that after the coating has been added to the target substrate 10, the signal-to-noise ratio improves dramatically. This result is quite unexpected. For instance, since no other change was made to the target, the sample composition or sample concentration, the expected result would have been to detect the same low signal results as without the solvent as used with AP-MALDI and MALDI ion sources and mass spectrometers. The use of such a target substrate 10 or application of a coating would not be expected to be effective in improving ion production in a matrix based ion source and mass spectrometer. However, it is believed that the invention operates by a large increase in nucleation resulting in increased quantity of uniform crystals from the concentrated liquid suspension of the supersaturated organic sample and analyte mixture. This may be explained by the fact that the hydrophobic surfaces reduce the overall surface tension of the molecules and cause them to further group or coalesce. Once the nucleation, drying and crystallization occur, the groups of molecules can then be more effectively and efficiently ionized and ejected as an ion plume into the ionization region. The drying of crystals produces a homogenous crystal field as opposed to a crater and rim on-homogenous crystal formation. The crater style crystallization takes place in other devices because of the drying of the crystals from rim to center. This produces an unequal distribution of crystals that results in less effective laser sampling and overall less efficient ionization, yielding lower instrument sensitivity. By forming the crystals differently by the natural nucleation process from the center, a more homogenous crystal distribution can be formed, resulting in an improved ionization plume from the matrix spot. Effective drying is a result of the hydrophobic surface that concentrates the sample and matrix into a tightly defined area.

It is to be understood that while the invention has been described in conjunction with the specific embodiments thereof, that the foregoing description as well as the examples that follow are intended to illustrate and not limit the scope of the invention. Other aspects, advantages and modifications within the scope of the invention will be apparent to those skilled in the art to which the invention pertains.

All patents, patent applications, and publications infra and supra mentioned herein are hereby incorporated by reference in their entireties.

### EXAMPLE 1

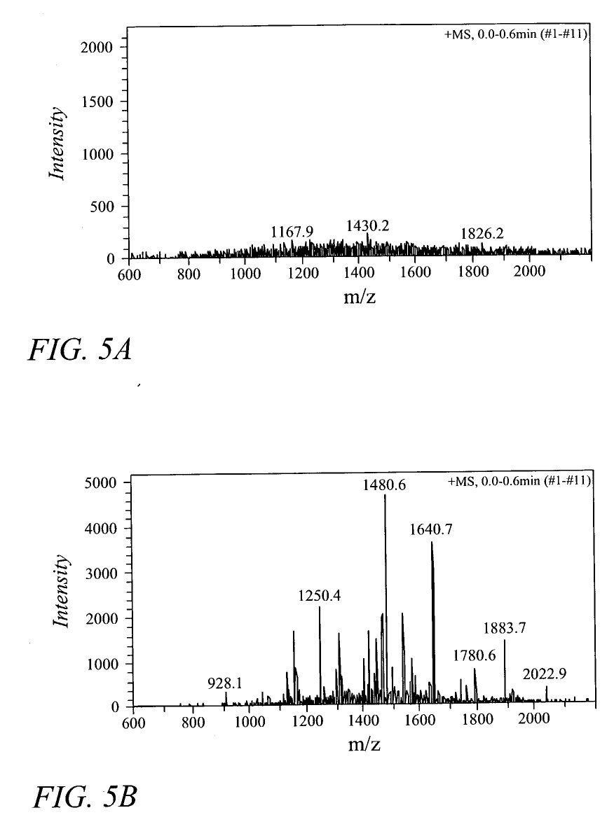

FIGS. 3A-5B show the application of the present invention to a target substrate. An ion trap mass spectrometer was used for all AP-MALDI studies. The ion-sampling inlet received a gas flow of 4-10 L/min. of heated nitrogen. A laser beam (337.1 nm, at 10 Hz) was delivered by a 400-micron fiber through a single focusing lens onto the target. The laser power was about 50 to 70 μJ. The data was obtained by using Ion Charge Control and setting the maximum trapping time to 300 ms (3 laser shots) for the mass spectrometer scan spectrum. Each spectrum was an average of 8 micro scans over the mass range of 400 to 2200 Da. The matrix comprises an 8 mM alpha-cyano-4-hydroxy-cinnamic acid in 25% methanol, 12% TPA, 67% water with 1% acetic acid. Matrix targets were premixed and 0.5 ul of the matrix/target mixture was applied onto a titanium nitride target substrate (See FIG. 5A). Analyte targets used included bovine serum albumin. Temperature of the gas phase in the vicinity of the target (ionization region) was about 100 degrees Celsius.

Sample plates composed of metal, glass, polymers or other suitable materials which can withstand temperatures of 180 degrees Celsius were physically cleaned with fine “Scotchbrite” pads, rinsed and cleaned with inorganic detergents followed by washing both with organic solvents. Solvents were 50% isopropanol, 24% acentonitrile, 25% cyclohexane and the cleaned plates were air dried. A 5% (weight) solution of methyl silicone gum rubber (OV-1) having an average of 125 KDa molecular weight was prepared in pentane. Care was taken to ensure better dissolution of the methyl silicon rubber (OV-1). Separately, a 5% solution of dicumylperoxide (DCHP) was prepared in toluene. The OV-1 solution and the DHCP catalyst solutions were mixed to give one percent catalyst content to the OV-1 solution. In one preparation, the plates or target platform surface was painted using a small artist brush. Up to 3 coatings were painted onto titanium nitride plates. A second process used the same solution and the plates were dipped into the solution only half deep allowing a portion of the plate to be coated. A third preparation used glass microscope slides and the dipping process was used to coat the one-half of the slide. The target substrates were allowed to air dry and placed onto a stainless steel tray. The polymer coated target substrates were transferred to an oven where they were baked for 35 minutes at 175 degrees Celsius to cross-link the polymer and create a large polymer molecule having a molecular weight greater than 3 million Da. The plates were removed and rinsed for two minutes by dipping in fresh methylene chloride to remove any excess peroxide residue. The plates were allowed to air dry and were spotted with a MALDI solution of BSA (as described below). Subsequently, mass analysis was performed on the samples resulting in the described spectra. The present invention has a few unique chemical properties. The coating or target substrate surface provides very strong hydrophobic surface coating that causes the MALDI solution to minimize surface wetting and spreading. This keeps the sample in a concentrated region where crystallization of the matrix salt and sample will develop favorably.

FIG. 5A shows the results without the addition of the coating to the target substrate. The figure does not show the existence of well-defined chemical analyte peaks at high or low m/z ratios. In addition, there is a high noise to signal ratio shown across the entire spectrum with no characteristic analyte mass peaks observed.

### EXAMPLE 2

Referring to FIG. 5B, the same targets were prepared and used as described above in FIG. 5A except that the process coating was applied to the target substrate according to the invention. The figure shows the existence of the well-defined chemical analytes peaks at the higher m/z ratios. In addition, the signal to noise ratio is significantly improved.

1. A target substrate for use with a matrix based ion source, having a target substrate surface comprising a hydrophobic polymer that promotes ion formation.

2. A target substrate as recited in claim 1, wherein the hydrophobic polymer comprises methyl silicone rubber gum.

3. A target substrate as recited in claim 1, wherein the matrix based ion source is a matrix assisted laser desorption ionization (MALDI) source.

4. A target substrate as recited in claim 1, wherein the ion source is a fast atom bombardment (FAB) ion source.

5. A target substrate as recited in claim 1, wherein the ion source is an atmospheric pressure laser desorption ionization (AP-MALDI) ion source.

6. A target substrate as recited in claim 1, wherein the ion source is at atmospheric pressure.

7. A target substrate as recited in claim 1, wherein the ion source is below atmospheric pressure.

8. A target substrate as recited in claim 1, wherein the ion source is above atmospheric pressure.

9. A target substrate as recited in claim 3, wherein the ion source is below atmospheric pressure.

10. A target substrate as recited in claim 3, wherein the ion source is above atmospheric pressure.

11. A mass spectrometer system, comprising:
(a) an irradiating source for ionizing a matrix based sample;
(b) a hydrophilic target substrate adjacent to the irradiating source for supporting the matrix based sample, the hydrophilic target substrate having a target surface comprising a hydrophobic polymer for concentrating the matrix based sample on the target surface before it is desorbed and ionized to form analyte ions;
(c) a collecting capillary downstream from the irradiating source for receiving the analyte ions produced from the matrix based sample; and
(d) a detector downstream from the collecting capillary for detecting the analyte ions received from the collecting capillary.

12. A mass spectrometer system as recited in claim 11, wherein the ion source is a matrix assisted laser desorption ionization (MALDI) source.

13. A mass spectrometer system as recited in claim 11, wherein the ion source is a fast atom bombardment (FAB) ion source.

14. A mass spectrometer system as recited in claim 11, wherein the ion source is an atmospheric pressure laser desorption ionization (AP-MALDI) ion source.

15. A mass spectrometer system as recited in claim 11, wherein the ion source is at atmospheric pressure.

16. A mass spectrometer system as recited in claim 11, wherein the ion source is below atmospheric pressure.

17. A mass spectrometer system as recited in claim 11, wherein the ion source is above atmospheric pressure.

18. A mass spectrometer system as recited in claim 11, wherein the ion source is at atmospheric pressure.

19. A mass spectrometer system as recited in claim 13 or 14, wherein the ion source is above atmospheric pressure.

20. A mass spectrometer system of claim 11, wherein the volume of the ionization region is from 1-5 mm³.

21. A method for producing and detecting analyte ions in a mass spectrometer system, comprising:
(a) applying a hydrophobic polymer to a target substrate for concentrating a matrix based sample; and
(b) ionizing the matrix based sample to produce analyte ions.

22. The method of claim 21, further comprising collecting the analyte ions in a collecting capillary before the analyte ions are detected.

23. An apparatus that produces analyte ions for detecting by a detector, comprising:
(a) a matrix based ion source having a target substrate comprising a methyl silicone material for producing analyte ions;
(b) an ion transport system adjacent to the matrix based ion source for transporting analyte ions from the matrix based ion source; and
(c) an ion detector downstream from the ion transport system for detecting the analyte ions.

24. An apparatus as recited in claim 23, wherein the ion detector comprises a mass analyzer.

25. An apparatus as recited in claim 24, wherein the ion transport system comprises at least one collecting capillary.

26. A mass spectrometer system, comprising:
(a) an ion source having a target substrate with a target substrate surface comprising a methyl silicone gum material for producing analyte ions;
(b) an ion transport system adjacent to the ion source for transporting the analyte ions from the ion source; and
(c) an ion detector downstream from the ion source for detecting the analyte ions.

27. A mass spectrometer as recited in claim 27, wherein the ion detector comprises a mass analyzer.

28. A mass spectrometer as recited in claim 27, wherein the ion transport system comprises a collection capillary.

29. A method for producing analyte ions for detection by a mass spectrometer, comprising:
(a) concentrating the analyte on a target substrate surface comprising a methyl silicone material;
(b) desorbing and ionizing the analyte to form analyte ions; and
(c) detecting the analyte ions with a detector.

30. A mass spectrometer system, comprising:
(a) a matrix based ion source comprising:
i. an irradiating source for ionizing a matrix and sample to form analyte ions; and
ii. a target support adjacent to the irradiating source for supporting the matrix and sample, the target substrate having a target surface comprising a methyl silicone gum rubber material for concentrating the matrix and sample on the target substrate surface;
(b) a collecting capillary downstream from the irradiating source and the target substrate for receiving the analyte ions; and
(c) a detector downstream from the collecting capillary for detecting the analyte ions received by the collecting capillary.
